(19) United States
(12) Patent Application Publication
(10) Pub. No.: US 2007/0158326 A1
(43) Pub. Date: Jul. 12, 2007

(54) Wax burning device

(76) Inventor: Ming-Ren Xiao, Toufen Township (TW)

Correspondence Address: TROXELL LAW OFFICE PLLC, SUITE 1404, 5205 LEESBURG PIKE, FALLS CHURCH, VA, 22041, US

(21) Appl. No.: 11/326,464

(22) Filed: Jan. 6, 2006

(51) Int. Cl. F27D 11/00; F27B 14/00

(52) U.S. Cl. 219/385; 219/420

(57) ABSTRACT

A wax burning device includes an electrically insulative and heat proof housing, a base with the housing mounted thereon, a heating element mounted in the housing, a resistor mounted in the heating element, a cord electrically interconnected the resistor and an external power source, a switch provided on the cord, a circuit board provided in the housing, and a light assembly including one or more LEDs formed on the circuit board and being electrically connected to the circuit board. Uniform light is emitted from the light assembly when the wax burning device is activating.

### BACKGROUND OF THE INVENTION

1) Field of Invention

The present invention relates to burning devices and more particularly to a wax burning device with improved characteristics.

2) Related Art

A conventional wax burning device is shown in FIG. 2 and comprises a cylindrical housing 30, a base 10 with the housing 30 mounted thereon, a heating element 40 mounted in the housing 30, a bolt 90 driven through the heating element 40 and the base 10 to fasten them together by threadedly securing to a nut 91, a resistor 20 mounted on a lower frame 41 of the heating element 40, an indicator 100 electrically connected to the resistor 20, a cord 50 electrically interconnected the resistor 20 and an external power source, and a switch 80 provided on the cord 50. The housing 30 is made of ceramic and the heating element 40 is made of metal. Another conventional wax burning device is shown in FIG. 1 and comprises a plurality of components substantially the same as above except an additional case 110 with the indicator 100 enclosed therein.

Both prior wax burning devices are capable of effectively controlling heating temperature and burning speed. However, people have to be sufficiently close to the wax burning device in order to clearly see the light emitted by the indicator. Further, the wax burning device is not aesthetic. Thus, continuing improvements in the exploitation of wax burning device are constantly being sought.

### SUMMARY OF THE INVENTION

It is therefore an object of the present invention to provide a wax burning device comprising an electrically insulative and heat proof housing, a base with the housing mounted thereon, a heating element mounted in the housing, a resistor mounted in the heating element, a cord electrically interconnected the resistor and an external power source, a switch provided on the cord, a circuit board provided in the housing, and a light assembly including one or more LEDs formed on the circuit board and being electrically connected to the circuit board wherein light is emitted from the light assembly when the wax burning device is activating.

In one aspect of the present invention the circuit board is electrically connected to the resistor in parallel and the circuit board is provided between the base and the heating element.

In another aspect of the present invention the housing is formed of a transparent plastic material or a transparent ceramic.

In a further aspect of the present invention the LEDs are serially connected and are grouped as two sets each adapted to emit light of color different from that emitted by the other set.

In yet further aspect of the present invention there is further provided an overload protection relay in series with the resistor.

The above and other objects, features and advantages of the present invention will become apparent from the following detailed description taken with the accompanying drawings.

### BRIEF DESCRIPTION OF THE DRAWINGS

FIGS. 1 and 2 are exploded views of two conventional wax burning devices;

FIG. 3 is an exploded view of a first preferred embodiment of wax burning device according to the invention;

FIG. 4 is an exploded view of a second preferred embodiment of wax burning device according to the invention; and

FIG. 5 is a circuit diagram of the resistor, the circuit board, and the switch according to the invention.

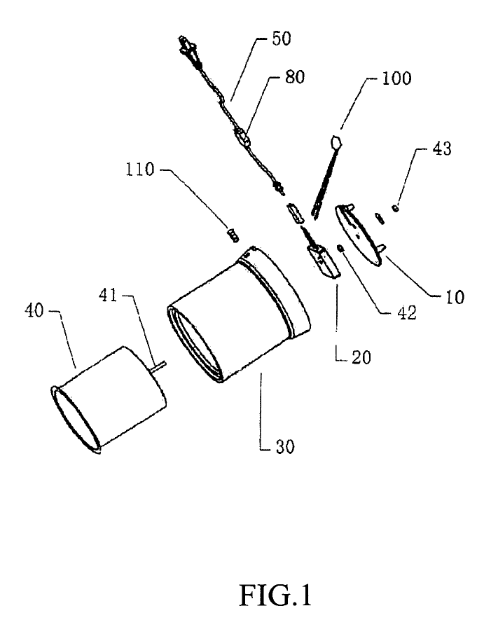

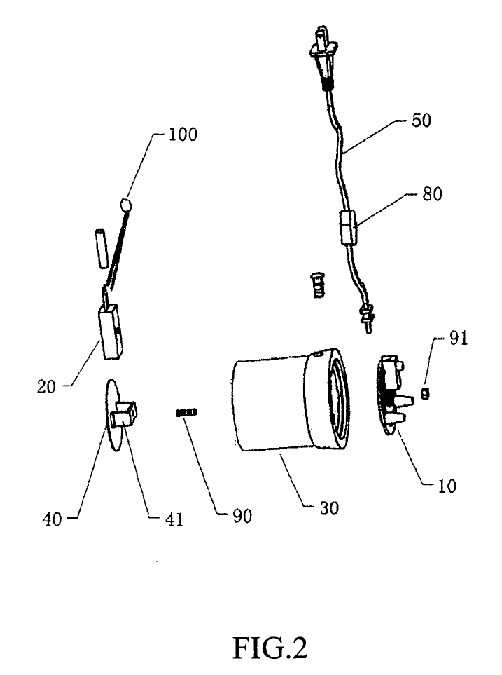

### DETAILED DESCRIPTION OF THE INVENTION

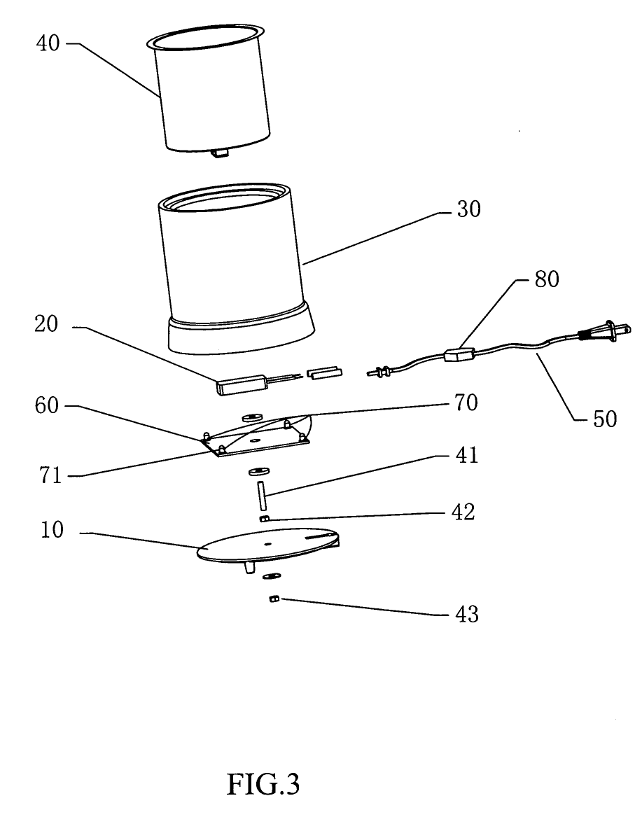

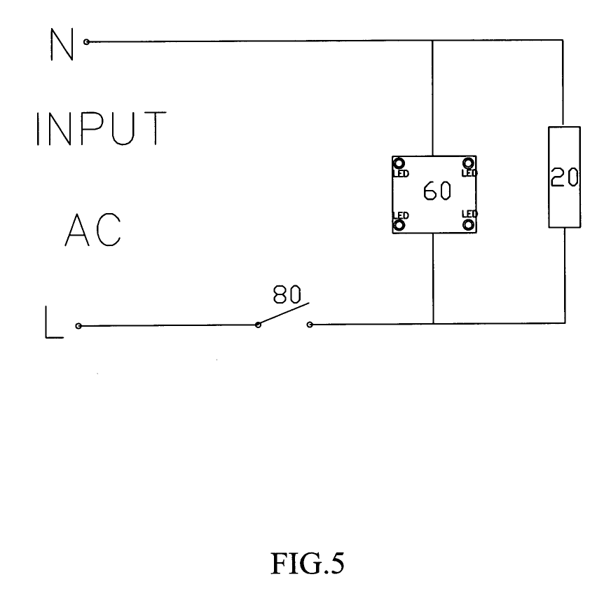

Referring to FIGS. 3 and 5, a wax burning device in accordance with a first preferred embodiment of the invention comprises a cylindrical housing 30, a base 10 with the housing 30 mounted thereon, a heating element 40 mounted in the housing 30, a bolt 41 driven through the heating element 40 and the base 10 to fasten them together by threadedly securing to a nut 43, a resistor 20 mounted in the heating element 40, a cord 50 electrically interconnected the resistor 20 and an external AC (alternating current) power source, and a switch 80 provided on the cord 50. The housing 30 is made of transparent plastic material or transparent ceramic. It is important that the housing 30 is required to be electrically insulative and heat proof so as to prevent the operating wax burning device from burning or causing electric shock to the hand touching it.

A rectangular circuit board 60 is provided in the housing 30 and a light assembly 70 including a plurality of (e.g., four) serially connected LEDs (light emitting diodes) 71 are mounted on four corners of the circuit board 60. Note that a light assembly 70 includes one LED is possible in other embodiments. The circuit board 60 is electrically connected to the resistor 20 in parallel (see FIG. 5) and the light assembly 70 is electrically connected to the circuit board 60. Thus, uniform light is emitted from the LEDs 71 when the wax burning device is activating. Preferably, the LEDs 71 are grouped as two sets each adapted to emit light of color different from that emitted by the other set. Further, light may pass the transparent housing 30 so that people can be visually informed that the wax burning device is operating.

Referring to FIG. 5 specifically, the resistor 20 in parallel with the circuit board 60 generates heat when the cord 50 is plugged into an AC outlet and the switch 80 is on. Thus, the heating element 40 is heated to quickly burn wax contained in the heating element 40. Also, the LEDs 71 may emit light. The circuit board 60 is provided between the base 10 and the heating element 40. The circuit board 60 is isolated from the external and thus is not subject to erosion and damage. Moreover, an overload protection relay (not shown) is in series with the resistor 20. The overload protection relay as a safety device is adapted to interrupt the power when wax in the heating element 40 has completely burned.

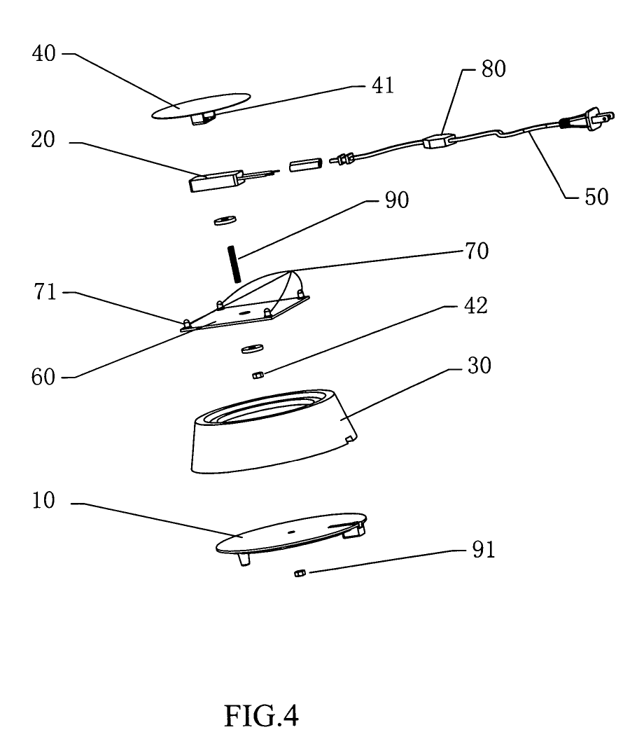

Referring to FIG. 4, a wax burning device in accordance with a second preferred embodiment of the invention is shown. The second preferred embodiment substantially has same structure as the first preferred embodiment. The differences between the first and the second preferred embodiments, i.e., the characteristics of the second preferred embodiment are detailed below. The housing 30 is lower and the heating element 40 is implemented as a plate.

An operation of the wax burning device may be briefed as below. Plug the cord 50 into an AC outlet. Next, turn on the switch 80. The resistor 20 then generates heat to heat the heating element 40 for burning wax. At the same time, light is emitted from the light assembly 70 and passes the transparent housing 30 so as to visually inform that the wax burning device is operating.

While the invention herein disclosed has been described by means of specific embodiments, numerous modifications and variations could be made thereto by those skilled in the art without departing from the scope and spirit of the invention set forth in the claims.

What is claimed is:

1. A wax burning device comprising an electrically insulative and heat proof housing, a base with the housing mounted thereon, a heating element mounted in the housing, a resistor mounted in the heating element, a cord electrically interconnected the resistor and an external power source, a switch provided on the cord, a circuit board provided in the housing, and a light assembly including one or more LEDs formed on the circuit board and being electrically connected to the circuit board wherein light is emitted from the light assembly when the wax burning device is activating.

2. The wax burning device of claim 1, wherein the circuit board is electrically connected to the resistor in parallel.

3. The wax burning device of claim 1, wherein the circuit board is provided between the base and the heating element.

4. The wax burning device of claim 1, wherein the housing is formed of a transparent plastic material.

5. The wax burning device of claim 1, wherein the housing is formed of a transparent ceramic.

6. The wax burning device of claim 1, wherein the light assembly comprises one LED.

7. The wax burning device of claim 1, wherein the light assembly comprises a plurality of LEDs.

8. The wax burning device of claim 7, wherein the LEDs are grouped as two sets each adapted to emit light of color different from that emitted by the other set.

9. The wax burning device of claim 7, wherein the LEDs are serially connected.

10. The wax burning device of claim 8, wherein the LEDs are serially connected.

11. The wax burning device of claim 1, further comprising an overload protection relay in series with the resistor.
